(19) United States
(12) Patent Application Publication
(10) Pub. No.: US 2008/0266884 A1
(43) Pub. Date: Oct. 30, 2008

(54) Cooling Device for Cooling a Semiconductor Component, in Particular, an Optoelectronic Semiconductor Component

(76) Inventors: Georg Bogner, Lappersdorf (DE); Herbert Brunner, Sinzing (DE); Stefan Grotsch, Lengfeld/Bad Abbach (DE); Guy Lefranc, Munchen (DE)

Correspondence Address: NEXSEN PRUET, LLC, P.O. BOX 10648, GREENVILLE, SC, 29603, US

(21) Appl. No.: 11/794,583

(22) PCT Filed: Dec. 1, 2005
(86) PCT No.: PCT/DE05/02168

§ 371 Date: Feb. 1, 2008

(30) Foreign Application Priority Data
Dec. 30, 2004 (DE) 10-2004-063-558.7

(51) Int. Cl. F21V 29/00

(52) U.S. Cl. 362/373

(57) ABSTRACT

The invention relates to a cooling device for cooling a semiconductor component (1), in particular an optoelectronic semiconductor component, comprising at least partially first and second layers and a heal dissipation device (4), wherein said first and second layers are flatly placed on top of each other and one layer is provided, at least partially, with a structure for receiving said heat dissipation device (4).

The invention relates to an apparatus for cooling a semiconductor component, in particular an optical semiconductor component, using liquid and gaseous media for heat transport.

In the context of the continuous rise in power of all kinds of semiconductor components generally, the associated increase in waste heat is one of the chief problems. Overheating of semiconductor components must be prevented because, primarily, it impairs the functioning and also, in the case of severe overheating, it can destroy the component.

The use of various cooling techniques for electrical semiconductor components is already known. The use of so-called heat pipes for dissipative heat transport in the case of optical components is known from the publication U.S. Pat. No. 6,252,726 B1.

The use of a thermosyphon to reject the excess heat energy of a specially implemented semiconductor component to the ambient air is cited in the publication US 2003/0151896 A1. Here a cooling apparatus having various parts, such as heat conductors and condenser regions, is additionally built in.

The use of optoelectronic semiconductor components such as light-emitting diodes (LEDs), lasers, or LED or laser arrays having high power is becoming more and more important in everyday practice. These are employed to replace conventional light sources in room illumination, automobile making, entertainment electronics, or as efficient sources of laser light. Up to now, optoelectronic semiconductor components have been mounted on metal screen, flex on aluminum, or metal-core plates in order that the heat produced by power dissipation can be better removed. On grounds of cost, active cooling systems are not generally employed.

Along with the power, the requirements on luminous flux and brightness of components have risen to such an extent that conventional cooling by heat sinks is no longer sufficient.

But an implementation of conventional separate cooling devices having heat conductors (heat pipe, thermosyphon) and condensers, because of the space that they require, impairs the potential applications of optoelectronic semiconductor components. The additional parts of the cooling device take up space, increase the weight, restrict design freedom, and occasion high costs. These facts represent limiting factors for the wider commercial use of optoelectronic semiconductor components.

It is an object of the invention to identify a cooling apparatus that is versatile in application in simplified fashion or capable of integration in a variety of ways. In particular, constituents of a cooling system are to be functionally integrated with a semiconductor component, in particular an optoelectronic semiconductor component. Constituents of a cooling system that are additionally capable of performing another function can preferably be integrated with a semiconductor component here.

This object is achieved with a cooling apparatus having the features of Claim 1. Advantageous developments of the invention are the subject of the dependent Claims.

Such a cooling apparatus is designed to cool a semiconductor component, in particular an optoelectronic semiconductor component, and exhibits in at least one or a plurality of subregions a first layer and a second layer and a device for heat removal, wherein the first layer and the second layer are disposed surface to surface and in at least one or a plurality of subregions one of the layers is provided with a structure that is designed to accommodate the device for heat removal.

The use of double-walled layer systems having integral conduits is especially advantageous here. Layer systems can be made up of structured and unstructured layers. They can be used as heat conductors (heat pipe) or as a thermosyphon or in combination with an integral porous solid as thermal base or as condenser region. At the same time, the individual layers, singly or in combination, can perform further functions, for example as a vehicle body part, as a lampshade, as a base, as a pillar, as a housing for a device, as a reflector, as an optical component, or also as a load-bearing part.

This dual functional concept has a plurality of advantages: The use of additional parts can be reduced or avoided because the cooling device can be integrated into one or a plurality of parts of a semiconductor device exhibiting a semiconductor component, such as one or a plurality of reflectors or a housing, the parts preferably being present anyway in the semiconductor device. Additional weight can be diminished or avoided in this way. The potential applications of cooling devices and optoelectronic semiconductor components are increased, and more power can be implemented in less space in simplified fashion.

An advantageous embodiment of the invention is offered by the integration of a thermosyphon for cooling. In a thermosyphon, the condensate of the coolant liquid is conveyed by gravity from a condenser region back to an evaporator unit. For this reason, the heat source or at least the evaporator unit must lie below the condenser region, so that in the operating state the liquid level lies above the object to be cooled with reference to the center of the Earth. In various embodiments of the invention, the condenser region, the evaporator unit, the connecting conduits or also only parts of these devices can be integrated into one or a plurality of double-walled layer systems. In a special case, the entire thermosyphon can also be contained in a double-walled layer system.

A further advantageous embodiment of the invention is characterized by the integration of a heat pipe. In such a heat conductor, liquid or gaseous media are used for heat transport. By virtue of the phase transition, the efficiency of heat conduction by thermosyphons and heat pipes, with a thermal conductivity of 4000 to 7000 W/m*K, is significantly greater than that of the best solid heat conductors. The thermal conductivity of diamond, for comparison, is only around 1000 to 2000 W/m*K.

A further advantageous embodiment of the invention results if the device contains a heat pipe, which serves to remove the waste heat of the optoelectronic semiconductor component efficiently to a location having a good thermopotential. Devices whose intrinsic temperature changes only slowly or slightly as they accept thermal energy are good thermopotentials.

A further advantageous embodiment of the invention results if the device contains a thermosyphon, which serves to remove the waste heat of the optoelectronic semiconductor component efficiently to a location having a good thermopotential.

A further advantageous embodiment of the invention results if the device contains a thermal base. A thermal base is a cooling device that functions analogously to a thermosyphon. The thermal base, however, additionally contains a porous filler, whose capillary action enables liquid transport independently of gravity.

A further advantageous embodiment of the invention results if the device contains a condenser region. Evaporated coolant liquid can condense in the condenser region, and thus a majority of the thermal energy previously absorbed can be rejected to, say, an external heat reservoir.

A further advantageous embodiment of the invention results if the device is partly or completely integrated into a housing or housing component containing the optoelectronic semiconductor component.

A further advantageous embodiment of the invention results if subregions of the layers are fashioned as mounting plates, because mounting the optoelectronic semiconductor component directly on layers of the device ensures more efficient heat removal. Additionally, subregions of the layers can also serve as mounting plates for further components of the device containing the optoelectronic semiconductor component.

A further advantageous embodiment of the invention results if one or a plurality of coolant liquid conduits are integrated into the layers in one-sided or double-sided fashion. With one-sided integration in particular, one side of the planar layer not provided with channels can be provided as mounting surface, for example for the semiconductor component. With double-sided integration, the conduit or conduits can attain symmetrical and/or larger cross sections, in particular a larger cross-sectional area.

A further advantageous embodiment of the invention results if the cooling device contains a condenser region and this condenser region, in at least one or a plurality of subregions of a cross section, exhibits a meander structure. Independently thereof, a subregion of the housing adjacent to the condenser region can also exhibit such a structure in order, in particular, to function as a good thermopotential.

A further advantageous embodiment of the invention results if the optoelectronic semiconductor component to be cooled by the cooling device is an LED array or contains a plurality of optosemiconductor chips. The optoelectronic semiconductor component can, however, also contain semiconductor lasers or individual conventional or organic LEDs.

A further advantageous embodiment of the invention results if one or a plurality of the conduits are implemented by one or a plurality of deep-drawn grooves in one or both layers. The fabrication of deep-drawn grooves, in particular in one or a plurality of metallic layers, offers a simple and economical fabrication method.

A further advantageous embodiment of the invention results if a porous solid material is inserted into one or a plurality of conduits of the device. In this way the construction of a thermal base can be implemented.

A further advantageous embodiment of the invention results if an element or a combination of one or a plurality of, in particular different, elements of the group comprising water, organic solvent, ethanol, triethylene glycol, fluorinated and/or chlorinated hydrocarbon, in particular a fluorocarbon, a chlorocarbon or a chlorofluorocarbon, for example Freon, is employed as coolant liquid in the device.

A further advantageous embodiment of the invention results if the device for heat removal contains a plurality of grooves that can form the conduits. These grooves can, for example, be disposed parallel or in a pattern similar to fish scales. Further embodiments, however, can also exhibit other suitable geometric patterns.

In an advantageous embodiment of the invention, one or a plurality of the layers contains, or the layers contain, a metal or metals, a metal alloy or metal alloys, a plastic or plastics, or a ceramic or ceramics. Two layers can contain different materials as appropriate.

A further advantageous embodiment of the invention results if the liquid level of the cooling device in the operating state, as viewed from the center of the Earth, lies above the disposition of the optoelectronic semiconductor component, in particular above the semiconductor component. In this way, condensate can flow back by gravity to the semiconductor component to be cooled and in this way used again for heat removal. A thermosyphon is implemented in this way.

A further advantageous embodiment of the invention results if one or a plurality of parts of the cooling device are integrated into a constituent of the device containing the optoelectronic semiconductor component. Because of the diverse potential applications of optoelectronic semiconductor components, the following can be identified by way of example: the housing of a projector, the housing of a lamp, a headlight or an automotive body part such as a fender, a motor hood, a door or a roof element. It is also possible to integrate the cooling device into an optical element of the semiconductor component such as a reflector, a filter or an illuminating means. A device according to the invention can also be integrated into a load-bearing element of an illuminating device such as a pillar or a base. The cooling device can be integrated into any planar and/or curved surfaces of components of devices containing optosemiconductors.

A reflector preferably exhibits at least one curved surface, which is suitable and/or designed for reflecting the radiation generated in the semiconductor component. With the reflector, radiation generated in the semiconductor component can be reflected and diverted, in particular into a specified direction. The cooling device is preferably at least partly integrated into a planar (sub)surface of the reflector or a device surrounding the reflector. A planar surface is particularly suitable for mounting the semiconductor component, a curved surface for diverting the radiation. In especially preferable fashion, the cooling device is integrated into the reflector of a headlight.

A further advantageous embodiment of the invention results if the coolant liquid used exhibits a boiling point that lies in the temperature range of the operating point of the optoelectronic semiconductor component. In this way, given appropriate sizing of the cooling device, a nearly constant temperature at the operating point can be maintained.

A further advantageous embodiment of the invention results if one or a plurality of the layers are structured by deep drawing, milling, injection molding, bending, shaping, stamping, etching or other plastic deformation methods. Grooves or conduits can be generated inside the double-walled construction by the application of high pressures to bonded layers, in particular to regions thereof. An example of this is the fabrication of channels inside double-walled constructions by the roll-bonding or Z-bonding method.

The cross sections, in particular the cross-sectional areas, of one or a plurality of channels can be adapted both to the kind of heat-transport medium and/or its quantity and also to the desired rate of heat transport.

A further advantageous embodiment of the invention results if one or a plurality of layers of the cooling device are totally or partly coated with further materials. Because the cooling device can be partly or totally integrated into various constituents of an illuminating device, additional coating is advantageous in many cases. For example, the cooling device can be integrated into a reflector and the surface of the reflector can be provided with an additional reflective coating, which has a more suitable reflectance and preferably acts to increase the reflection. In illuminating devices that exhibit an integrated cooling device in an external surface, a paint or lacquer coating can advantageously be applied for esthetic reasons.

In correspondence with the functioning of a constituent of the cooling device, adhesive coatings, luminescent coatings, reflective dirt-repelling, self-cleaning, electrically and/or thermally conductive coatings can be advantageous.

A further advantageous embodiment of the invention results if the layers of the cooling device are bonded at least in one or a plurality of subregions. A device for cooling the component can then be integrated into these subregions. Unbonded subregions of the layers, in contrast, can also be advantageous on design grounds. For this reason, the layers need not be disposed surface to surface in all regions. Forming of one or a plurality of substantially tight conduits, however, should preferably not be made more difficult thereby. All current joining techniques, such as for example adhesive joining, welding, clipping, snapping, brazing or hot calking, are candidate joining methods. A welded joint can be executed as a diffusion-welded joint.

A further advantageous embodiment of the invention results if the bonded layers tightly enclose the coolant liquids and their gas at least in one or a plurality of subregions. The cooling process can be formed as a closed loop in simplified fashion in this way.

A cooling device according to the invention can advantageously be at least partly integrated into an information reproducing device. This is particularly advantageous when the information reproducing device exhibits a display device, for example a device for image reproduction, because large quantities of waste heat can arise here in case of illumination.

A projection device, in particular a rear-projection (television) set, can advantageously be equipped with one or a plurality of cooling devices according to the invention. Here frames, mounting platforms, diverting mirrors and mirror holders are particularly well suited for at least partly integrating therein a cooling device according to the invention.

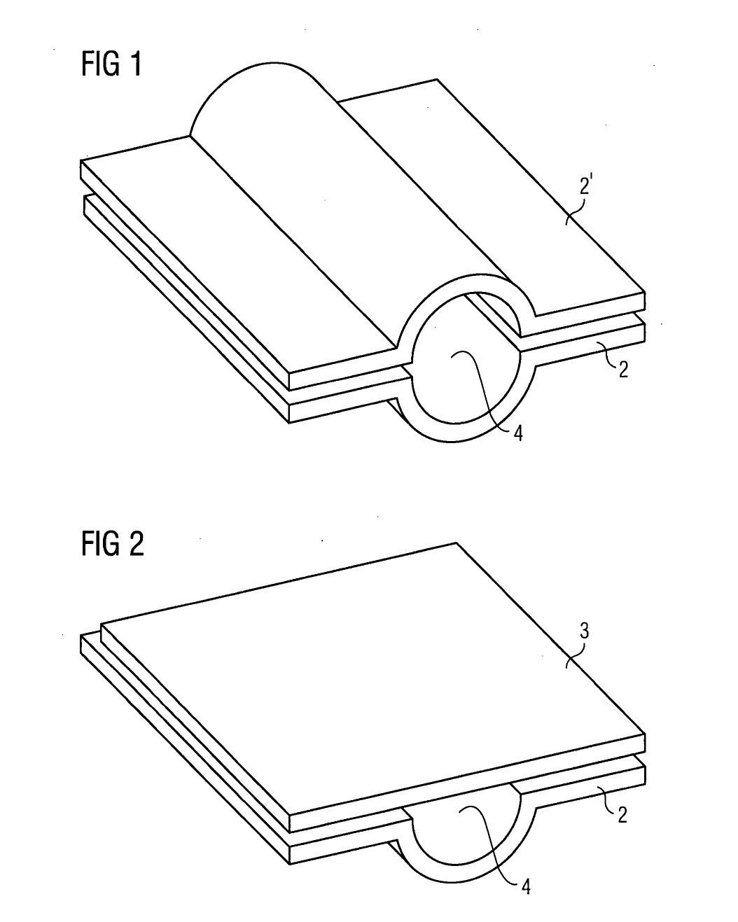

In what follows, the invention is explained in greater detail on the basis of preferred embodiments with reference to FIGS. 1 to 6, which are merely schematic or perspective illustrations and not to scale, in which:

FIG. 1 depicts the design principle of the cooling device having two structured layers;

FIG. 2 depicts the design principle of the cooling device having one structured and one unstructured layer;

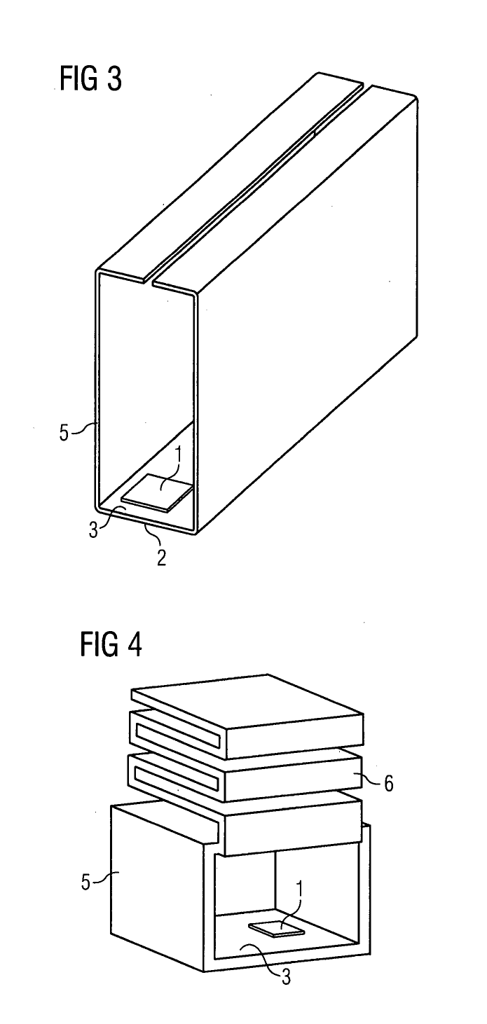

FIG. 3 depicts an example of a housing shape with integrated cooling device;

FIG. 4 depicts an example of a housing shape with integrated cooling device;

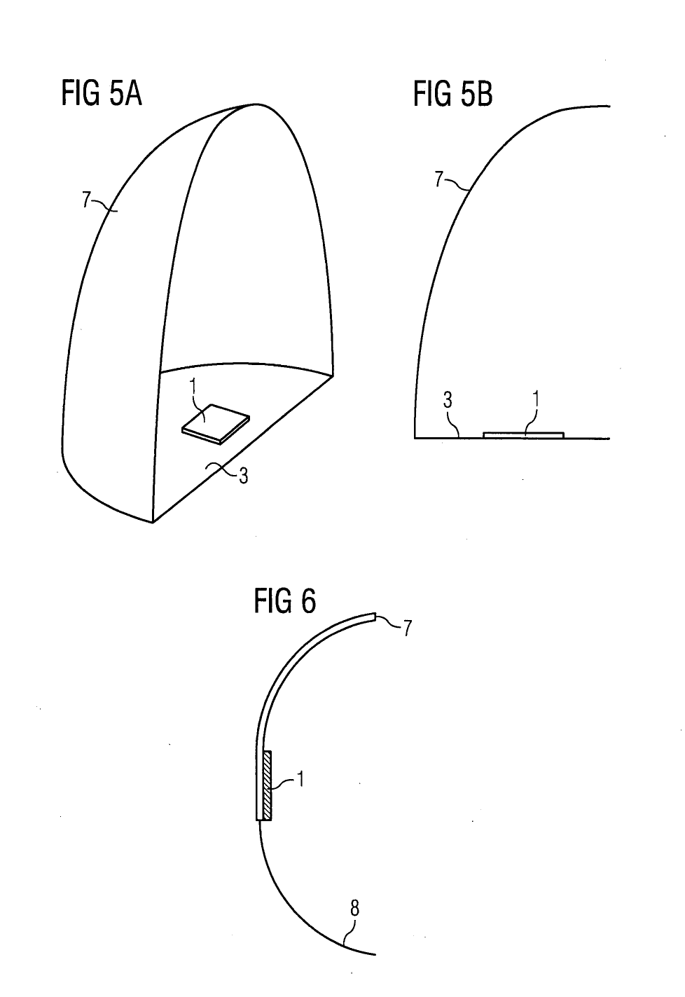

FIG. 5 presents a perspective view (5a) and a cross-sectional view (5b) of an illuminating disposition with integrated cooling device in the reflector; and

FIG. 6 is a cross-sectional view of an illuminating disposition with integrated cooling device in the reflector.

FIG. 1 depicts in simplified form an advantageous embodiment of the cooling device with integrated conduit. Here two structured layers 2 and 2′ having grooves worked into them are each mounted in such fashion relative to the other that the two grooves lie with their open sides fitting together and thus forming a conduit that is suitable for accommodating a device for heat removal 4. In this advantageous exemplary embodiment, the cross section of the grooves is semicircular in shape.

Further embodiments, however, are also possible with other cross-sectional geometries, triangular or rectangular shapes being identified here by way of example. Because the principle is being illustrated in simplified form, only a single conduit is drawn in FIG. 1.

Advantageous embodiments can, however, contain a plurality of such conduits. Depending on the application, these conduits can be applied in various geometric patterns. Fish-scale patterns, parallel periodic dispositions of channels, but also irregular dispositions that, for example, reinforce the stability of the device are also conceivable.

When working the grooves or depressions in, care should be taken that these are fashioned to fit together in mirror-image fashion so that, upon assembly of individual layers 2 and 2′, the depressions lie fitting together and forming conduits. In a special embodiment, the disposition of the structure can be chosen such that both layers 2 and 2′ are implemented with just one shaping tool. Upon assembly, both layers 2 are bonded together in such fashion that the resulting conduits are tightly sealed and a double-walled construction is produced. The bonded layers here form the walls of the construction. All customary joining techniques, such as for example adhesive joining, welding, clipping, snapping, brazing or hot calking, are candidates for making a joint.

In an embodiment not illustrated here, an additional layer can also be inserted between layers 2 and 2′ or 2 and 3 in order to seal the conduits or to bond the layers, the additional layer being fashioned as interrupted at the locations of the depressions, at least in subregions. Such an additional layer can be made of one or a plurality of plastic and/or elastic materials in order to permit sealing of the conduits. What is more, an additional layer can also effect or promote joining between the two outer layers; for example, the layer can be adhesive on both sides.

FIG. 2 depicts in simplified form a further embodiment of the construction principle according to the invention, wherein the depressions of the conduits are worked into a layer on only one side. Thus planar layer 3 can, for example, be used as a mounting surface. Further embodiments can also be blended forms of the construction principles illustrated in FIGS. 1 and 2. For example, conduits according to FIGS. 1 and 2 can transition one into the other or be disposed side by side.

In FIG. 2, similarly to FIG. 1, only a single conduit is illustrated. With regard to further embodiments having multiple channels according to the principle of FIG. 2, the dispositions identified in the description of FIG. 1 are also feasible here. The resulting conduits can accommodate devices for heat removal, which can be fashioned as both open and closed cooling systems.

FIG. 3 depicts further advantageous embodiments of the invention. Here a semiconductor 1, in particular an opto-semiconductor, is mounted on a layer 3, which corresponds to the construction principle of FIG. 2 at least beneath semiconductor 1. The remainder of the housing can then be built in accordance with the construction principles of FIG. 1 or 2. The conduits beneath the semiconductor communicate with channels in the remainder of the housing. This communication can be effected in the form of a thermosyphon or in the form of a thermal base. Layers 2 or 3 together with their respective mating parts form the double-walled housing structure 5.

FIG. 4 depicts a housing structure analogous to FIG. 3 and fashioned as double-walled at least in subregions, one housing part 6 being fashioned in meander form. This embodiment contains a larger area and thus increases heat removal in this region.

Housing part 6 in meandering form can be fashioned as single-walled or double-walled, with or without integrated cooling device.

Housings such as those illustrated in FIGS. 3 and 4 are suitable, for example, as structural shapes for LED projectors. The cooling device of opto-semiconductor 1 in both cases is functionally integrated into the housing structure.

FIG. 5a depicts the functional design of a condenser region as reflector 7. The conduits run inside the double-walled or double-layered construction of reflector 7 according to the invention. The inner face of the reflector can additionally be coated with a reflection-reinforcing material, or only the reflectance of a bright metal such as for example aluminum can be employed.

The fashioning of the mounting region beneath opto-semiconductor 1 corresponds to the construction principle of FIG. 2. The remaining region can be fashioned analogously to the construction principle of FIG. 1 and/or FIG. 2.

FIG. 5b depicts a cross section of the embodiment of FIG. 5a in a section plane through semiconductor component 1. Here it can be seen that the reflector structure can advantageously be fashioned both as a thermosyphon having gravity-driven condensate return and also as a thermal base having a porous filler material and condensate return driven by capillary force, in particular oppositely to the gravitational force. The outer face of the reflector can additionally contain cooling fins.

FIG. 6 depicts a cross section through a further embodiment of a reflector as thermosyphon according to the invention. A portion of reflector 7 in the upper region is fashioned according to the principles of FIGS. 1 and 2; the conduits together with the contained liquid represent a thermosyphon.

Opto-semiconductor 1 is affixed to a region of reflector 7 that corresponds to the principle of FIG. 2. Lower part 8 of the reflector is fabricated with conventional technology, without additional function, because the heat-absorption and evaporation region of the thermosyphon thus already lies below the heat source in relation to gravitation. Lower part 8 of the reflector is now not utilized as cooling device and accordingly does not need a double-walled design.

This patent application claims the priority of German patent application DE 10 2004 063 558.7, dated Dec. 30, 2004, the entire content of which is hereby explicitly incorporated into the present patent application by reference.

The invention is not restricted by the description based on exemplary embodiments. Instead, the invention comprises every new feature as well as every combination of features, which includes in particular every combination of features in the Claims, even if such feature or such combination is not itself explicitly identified in the Claims or exemplary embodiments.

1. A cooling apparatus for cooling a semiconductor component (1), in particular an optoelectronic semiconductor component, which exhibits at least in subregions a first layer and a second layer and a device for heat removal (4), wherein the first layer and the second layer are disposed surface to surface and one of the layers, at least in subregions, is provided with a structure that is designed to accommodate the device for heat removal (4).

2. The cooling apparatus of claim 1 wherein the cooling apparatus contains at least one element from the group thermosyphon, heat pipe, thermal base and condenser region.

3. The cooling apparatus of claim 1 wherein at least one heat pipe connects the semiconductor component to a good thermopotential.

4. The cooling apparatus of claim 1 wherein at least one thermosyphon connects the semiconductor component to a good thermopotential.

5. The cooling apparatus of claim 1 wherein the cooling apparatus is integrated into a housing (5) containing the semiconductor component.

6. The cooling apparatus of claim 1 wherein one of the layers, at least in subregions, is fashioned as a mounting plate for optical components.

7. The cooling apparatus of claim 2, characterized by a cooling fin region in meander form.

8. The cooling apparatus of claim 1, characterized by an additional heat exchanger.

9. The cooling apparatus of claim 1 wherein the semiconductor component (1) to be cooled contains an LED array or at least one opto-semiconductor chip.

10. The cooling apparatus of claim 1 wherein the device for heat removal (4) is formed from at least one conduit that contains a coolant.

11. The cooling apparatus of claim 10 wherein the conduit is formed by a groove in at least one of the two layers.

12. The cooling apparatus of claim 11 wherein the conduit is at least partly filled with a porous solid.

13. The cooling apparatus of claim 1 wherein the device for heat removal (4) contains, as medium for heat transport, an element or a mixture of elements of the group comprising water, organic solvent, ethanol, triethylene glycol, fluorinated and chlorinated fluorocarbons.

14. The cooling apparatus of claim 11 wherein the layers contain a material of the group formed from metal, metal alloys, plastics and ceramics.

15. The cooling apparatus of claim 1 wherein at least parts of the cooling apparatus are fashioned as a reflector for the optoelectronic component.

16. The cooling apparatus of claim 1 wherein at least a part of the cooling apparatus is integrated into a housing part of an element from the group housing of a projector (5), housing of a lamp, housing of a headlight and automobile body part.

17. The cooling apparatus of claim 16 wherein at least one of the layers is at least partly covered by a further layer.

18. The cooling apparatus of claim 11 wherein the first layer and the second layer are at least partly joined by one or a plurality of joining techniques of the group comprising adhesive joining, welding, clipping, snapping, brazing and hot calking.

19. The cooling apparatus of claim 11 wherein the two layers, at least in subregions, tightly enclose a liquid or a gas.

20. The cooling apparatus of claim 1 wherein at least a part of the cooling apparatus is integrated into a constituent of an information reproducing device.

21. The cooling apparatus of claim 20 wherein the information reproducing device exhibits a device for image reproduction.

22. The cooling apparatus of claim 21 wherein the information reproducing device is a rear-projection television set.

23. The cooling apparatus of claim 22 wherein at least a part of the cooling apparatus is integrated into an element of the group frame, mounting platform, diverting mirror and mirror holder of the rear-projection television set.
